(19) United States
(12) Patent Application Publication
(10) Pub. No.: US 2016/0217463 A1
(43) Pub. Date: Jul. 28, 2016

(54) PAYMENT-BASED AUTHENTICATION SYSTEM

(71) Applicant: Roberto Rigotto de Gouvea, Belo Horizonte (BR)

(72) Inventor: Roberto Rigotto de Gouvea, Belo Horizonte (BR)

(21) Appl. No.: 14/603,673

(22) Filed: Jan. 23, 2015

(51) Int. Cl. G06Q 20/38; G06Q 20/10; G06Q 20/40

(52) U.S. Cl. CPC G06Q 20/3829; G06Q 20/4014; G06Q 20/108

(57) ABSTRACT

The present patent refers to procedures and technology that enable a new model for authenticating and/or expressing the electronic will of a particular user by using the infrastructure and security in the payment methods available in the finance system.

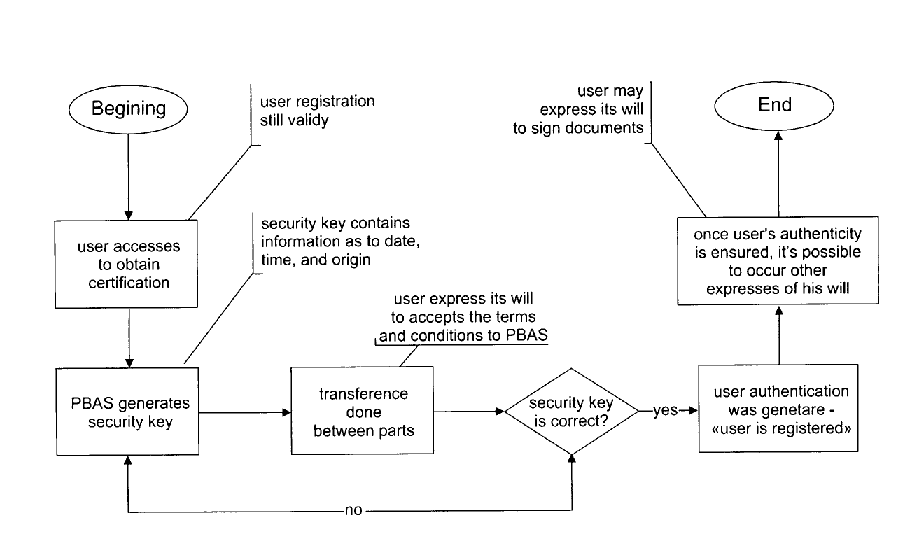

The object of this patent, consists of using the Finance and Banking System to electronically generate user registration, (with assurance of authenticity and integrity), thus enabling his or her expression of will, in an electronic, computerized manner, thus doing away with the need for the parties involved to be physically present and works as follows:
1—Initially, the methods and access to the “Terms and Conditions of Acceptance of Service” are made available to the user (economic entity or individual);
2—If the user accepts (agrees to) the terms, a set of instructions with unique, specific data is generated, called a security key, which will let the user carry out a bank transfer using the methods from the finance and banking system.
3—The author's authenticity is ensured through the user's access to his or her own financial institution (where he/she has a checking account) and the integrity of the information is also assured through the act of making the bank transfer.
4—The simple act of making this payment-based transfer, as per the security key data, sets and formalizes the user's electronic acceptance of the conditions.
5—At the end of the process, there is an authentic payment-based user registration, which can be used in the future for other operations connected with the “PAYMENT-BASED AUTHENTICATION SYSTEM.”

### APPLICATIONS OF THE PRESENT PATENT

Authenticating an economic entity's expressed will electronically/through the Internet with the Finance System;

Economic entity's authentication and assurance in a correct, legally exact and complete, secure, and incontrovertible way;

Legal exactness in financial transactions for the secure and incontrovertible identification of the actor in the economic-financial transaction, along with their monetary values and event dates.

E-commerce.

Marketing, satisfying the consumers' wishes.

The present invention refers to procedures and technology that enable a new model for authenticating and/or expressing the electronic will of a particular user by using the infrastructure and security in the payment methods available in the finance system.

Accordingly, there are two direct applications of this invention:

1^{st}—The first application ensures and electronically authenticates the user's authenticity in a correct, secure, and incontrovertible manner.

2^{nd}—The second application ensures and authenticates the user's expressed will, and in this case, the same user's authenticity is ensured.

### STATE OF THE ART

The internet—World Wide Web—It was originally created in the 1970s by the military for the purpose of having a reliable communication network in case of military conflict and having a reliable communication network available between all network nodes, even if some of them were inoperative. Then, in the 1980s, in order to provide and share scientific information, which then existed in various, incompatible computer “formats”, young scientists at the European Organization for Nuclear Research (EONR) made access to the network and its documents extremely easy to anyone with only minimal skills in dealing with digital equipment.

The “network” soon revealed its formidable democratic power, i.e., it was easy to use and allowed quick, easy, and direct exchange of messages between people, allowing each member of society to express his or her opinion, among themselves or between groups; at the time, public opinion was created only through mass media in a one-way system, and this contribution is now regarded as one of the most important changes in human history with respect to the information environment, the economic and social consequences of which are still poorly understood.

It was never the intention of the “Web” creators to have it used for commercial purposes; however, a tool with such a powerful market potential was soon snatched up by software and network creators and, within a short span of time, they had founded a new “e” (for electronic) economy, which, in less than a decade, made these young guys the richest men in the world, with personal assets greater than those of large century-old companies.

Currently, the message sending and receiving terminals through the web are “mobile”, i.e., they don't rely on cables and transmit hundreds of megabytes per second, in the form of voice, music, video images, and data.

The Web's increased use and effectiveness was due to its commercial use; all of the billion-dollar billing comes from advertising—whether or not explicit—plus the possibility of making purchases, payments, bank transfers, obtaining financial credits, and other real-time transactions.

However, the Web environment can also be extremely threatening and all kinds of illegal actions take place within it; today's world is witnessing the first “computer-literate” generation, many of whom have the gall and ability to defraud the Web users' defense mechanisms.

They remind us of the 17^{th} and 19^{th} century pirates who used their audacity and knowledge of navigation and naval warfare to attack and plunder ships from other nations.

Pirates did not always act on their own; often they were enlisted in the service of the various empires that existed at the time.

Internet pirates are known as “hackers” who enjoy breaking into the security systems of the site of major countries, their governments, military forces, and industries; like the seafaring pirates of yore, they often render services for other governments, as was revealed by recent attacks against Brazilian businesses and the federal government.

However, as soon as the financial and commercial agents realize their systems have been hacked into, they respond quickly to correct it.

The great appeal of being able to easily buy, pay, and transfer money and goods through the Internet, through e-commerce or e-Bank, clearly indicates this is the future of these sectors: banks and humongous companies like Amazon and China's Ali Baba move billions of dollars a year through their worldwide services.

Banks and e-commerce businesses use many different security systems, some of which they have developed themselves, others used by other companies, all aimed at preventing fraud and, at the same time, making it easier to use the computer in these types of transactions.

Assurance of authenticity is critical for a particular expression of will to be carried out by electronic means.

In order for that to happen, it should be possible to identify the user of the will recorded for each event carried out by computer.

There are two basic ways to ensure authenticity based on current state of the art:

1^{st}—The first option for user authentication employs the conventional model that has been in use for hundreds of years, namely, the user's physical presence and his or her signature (in ink) physically written on paper. This option is used to ensure user authenticity. Consequently, one can ensure the expression of acceptance of this particular user in a particular agreement, for example. This act, meaning the signature, is the user's identification and authentication, and when applied to a document, reflects his or her statement of awareness and acceptance of the terms and conditions set forth in the document. Although traditional, this model has a number of shortcomings, including:

A—The need for the user's physical presence as the author of the signature and then sign the document, which greatly limits the possibilities for executing the document and getting the signature on the printed document.

B—In order to comply with the requirement to prove the authenticity of a signature, a Notary Public Office often needs to be involved so there is certification that a particular signature corresponds to the registered signature of a particular individual, thus ensuring its authenticity. Without this proof, a party could claim that he or she was not the author of the signature on the document.

2nd—The second option for ensuring user authentication and his or her expression of will uses technology known as “Digital Certificate” and “Digital Signature”, respectively. This is a less widespread model for user identification and the execution of digital agreements and documents. To apply this type of format, the electronic document—rather than a printed one—requires a digital certificate that ensures the sender's authenticity. A digital certificate is an electronic device digitally validated by a Certificate Authority and containing data about the issuer and its holder. The function of the digital certificate is to link a person or entity with a public key. However, to get a digital certificate, the applicant needs to go to a Registration Authority, where he or she will be identified upon presenting various personal documents. The physical presence of the future holder is essential since this electronic document will be his or her “identification card” in the virtual world. In other words, to have legal validity, the certificate must be issued by a recognized certifying body, which makes it difficult to universalize access to digital certificates. It is worth remembering that digital certificates have an expiration date, requiring renewal from time to time to continue being used. Thus, the current models—both traditional and digital—entail some limitations that make it difficult and expensive to get authentication, or manifestation of will, herein exemplified through the execution of agreements, terms, and documents with signatures, which hinders or even prevents the use of the tremendous advantages ushered in by the e-commerce system.

Advances in the State of the Art brought by the “PAYMENT-BASED AUTHENTICATION SYSTEM”, object of this patent.

The object of this patent advances the State of the Art because it offers a solution that will enable authentication and manifestation of will to be done electronically and securely, using payments methods, which overcomes the various difficulties and limitations imposed by the other methods described in the State of the Art.

The new model unveiled in this report, called “PAYMENT-BASED AUTHENTICATION SYSTEM”, carries out electronic/computer-based identification (authenticity) using the payment system's existing security features and infrastructure, along with the legal requirements adopted in the Finance System, which makes it simple and easy to widely adopt this new model.

The “PAYMENT-BASED AUTHENTICATION SYSTEM”, object of this patent, consists of using the Finance and Banking System to electronically generate user registration, (with assurance of authenticity and integrity), thus enabling his or her expression of will, in an electronic, computerized manner, thus doing away with the need for the parties involved to be physically present.

The “PAYMENT-BASED AUTHENTICATION SYSTEM” works as follows:

1—Initially, the methods and access to the “Terms and Conditions of Acceptance of Service” are made available to the user (economic entity or individual);

2—If the user accepts (agrees to) the terms, a set of instructions with unique, specific data is generated, called a security key, which will let the user carry out a bank transfer using the methods from the finance and banking system.

3—The author's authenticity is ensured through the user's access to his or her own financial institution (where he/she has a checking account) and the integrity of the information is also assured through the act of making the bank transfer.

4—The simple act of making this payment-based transfer, as per the security key data, sets and formalizes the user's electronic acceptance of the conditions.

5—At the end of the process, there is an authentic payment-based user registration, which can be used in the future for other operations connected with the “PAYMENT-BASED AUTHENTICATION SYSTEM.”

As an example, the following scenario describes an application carried out by using the “PAYMENT-BASED AUTHENTICATION SYSTEM”:

Company “X” negotiates an agreement with the user and, through the object of this patent, which is developed as described above, the resource that produces authentication is used so that the agreement can be electronically signed; Company “X” posts the document—for instance, an agreement—on a web site that is part of the “PAYMENT-BASED AUTHENTICATION SYSTEM” so the parties have access to it and are fully knowledgeable of the conditions to be legally set forth between them, should both parties sign it.

The Agreement, as proposed as an example in the above paragraph, may already be displayed as having been digitally signed by Company “X”, through its digital certificate, showing that it is in agreement with and committed to the conditions described in it and now is waiting for the user's electronic signature.

All accesses to the document—represented by the Agreement—are duly registered by the “PAYMENT-BASED AUTHENTICATION SYSTEM”, making it possible for the legal act embodied by its execution to be audited at any time, because it contains information as to date, time, and origin, such as IP address—“Internet Protocol” on which the Agreement was made between the parties.

Following the client's agreement, represented by his or her signature that he or she assents to the contractual conditions, a set of instructions is generated with specific and necessary information so the user will be able to make a bank transfer, as per the Agreement.

The act of making the bank transfer through interbank payment, as per the generated “instruction”, results in the authentication of the client's complete registration data by means of the payment, which will enable him or her to execute any manifestation of will, such as the electronic signature on a document.

The term “instruction”, used in quotation marks in the above paragraph, refers to a security key; this security key is a combination of information needed to make a transfer through the payment methods. For example, if the client wants to make a transfer using a DOC (Credit Order Document), a security key will be generated containing sender and creditor information:

A) Full name,

B) Social Security Number (SSN) or equivalent,

C) Bank and Branch,

Account Number, and

E) Transaction Amount. Additional information, such as “Purpose of Transfer” may also be included.

For the purposes of this Patent Report, the expression “Payment Method” means any of the forms of payment and/or intra- and inter-bank transfers, for example, SWIFT (Society for Worldwide Interbank Financial Telecommunication) used to make transfers, such as Wire Transfer that, through information such as RTN (routing transit number)/ABA number (American Bankers Association), carries out financial transfers within the North American Finance System.

Furthermore, the solution presented herein makes it possible for the transfer to be carried out through credit or debit cards.

In the event of such a transfer, carried out according to the “instructions” in the Security Key, it will then be shown that the user used the finance system's secure infrastructure, on his or her own accord, to allow identification authentication. User authentication safety is possible owing to the requirements and regulations imposed by the Finance System for the registration and complete user identification at the time of opening a deposit account at a financial institution. This registration will allow him or her to carry out financial transactions through payment methods, such as PayPal®. Once the transfer has been made, the receiving financial institution will receive the credit and the “PAYMENT-BASED AUTHENTICATION SYSTEM” will check to ensure the security key's accuracy. In case of any discrepancy in the Security Key information used to make the transfer, the “PAYMENT-BASED AUTHENTICATION SYSTEM” will ask the credited bank to chargeback/refund the credit to its source and not carry out user authentication. In the case of an exact match with the Security Key, the “PAYMENT-BASED AUTHENTICATION SYSTEM” will continue to the next step—described below—in which user authentication will be effected, thus allowing the subsequent signing of the document.

At that moment, Company “X” may express its will and add its digital signature to the electronic document. The “PAYMENT-BASED AUTHENTICATION SYSTEM” includes the option of adding information to the document before it is signed, such as that used in the wire transfer, consisting of data related to the source/sender (Customer name, SSN or its equivalent, bank, branch, and account number), recipient data (name, SSN or its equivalent, bank, branch, and account number), and date and time at which the transfer took place.

Thus, as described, the “PAYMENT-BASED AUTHENTICATION SYSTEM” fully ensures the user's authenticity and the possibility of certifying his or her expression of will.

To facilitate the understanding of the functionality of the application, it is included a simple diagram illustrating how it works, from the beginning—user access—to the end of the operation.

1. “PAYMENT-BASED AUTHENTICATION SYSTEM” is intended to make possible a new authentication model and/or electronic manifestation of a particular user's will by using the infrastructure and security features offered by the payment methods available in the finance system, thus doing away with the need for the physical presence of the parties involved, ensuring and electronically authenticating user authenticity in a correct, secure, and incontrovertible manner and authenticating the user's expressed will, characterized by the fact it consists of using the Finance and Banking System to generate an electronic user registration with assurance of authenticity and integrity, and made available to the user (either an economic agent or individual):
The methods and access to the “Terms and Conditions of Acceptance of Service”;
If the user accepts (agrees to) the terms, a set of instructions with unique, specific data is generated, called a security key, which will let the user carry out a bank transfer using the methods from the finance and banking system;
The author's authenticity is ensured through the user's access to his or her own financial institution (where he/she has a checking account) and the integrity of the information is also assured through the act of making the bank transfer;
The act of making this payment-based transfer, as per the security key data, sets and formalizes the user's electronic acceptance of the conditions;
At the end of the process, there is an authentic payment-based user registration, which can be used in the future for other operations connected with the “PAYMENT-BASED AUTHENTICATION SYSTEM.”

2. “PAYMENT-BASED AUTHENTICATION SYSTEM,” in accordance with claim 1, is characterized by generating a security key containing sender and creditor information:
Full name,
Social Security Number (SSN) or equivalent;
Bank and Branch;
Account Number; and
Transaction Amount and/or Additional information may also be included.

3. “PAYMENT-BASED AUTHENTICATION SYSTEM”, in accordance with claim 1, is characterized by the fact that when a transfer is made, the receiving financial institution will receive credit and the “PAYMENT-BASED AUTHENTICATION SYSTEM” will check to ensure the security key's accuracy, and if there is any discrepancy in the security key's information used in the transfer, the “PAYMENT-BASED AUTHENTICATION SYSTEM” will ask the credited Bank to chargeback/refund the credit to the source and not carry out user authentication.

4. “PAYMENT-BASED AUTHENTICATION SYSTEM”, in accordance with claim 1, is characterized by the fact that when there is an exact match with the Security Key, the “PAYMENT-BASED AUTHENTICATION SYSTEM” will continue to the next step in which user authentication will be carried out, allowing the subsequent signing of the document, to which other information may be added before its signing, such as that used in the wire transfer, consisting of the source's/sender's data—Customer name, SSN or its equivalent, bank, branch, and account number—and recipient data—name, SSN or its equivalent, bank, branch, and account number, date and time at which the transfer took place.
